(19) United States
(12) Patent Application Publication
(10) Pub. No.: US 2001/0037297 A1
(43) Pub. Date: Nov. 1, 2001

(54) Bill paying with the aid of a scanner

(76) Inventor: Edward Parry McNair, Las Cruces, NM (US)

Correspondence Address: EDWARD P. MCNAIR, 6796 VIA CAMPESTRE, LAS CRUCES, NM, 88005, US

(21) Appl. No.: 09/802,374

(22) Filed: Mar. 8, 2001

Related U.S. Application Data
(60) Provisional application No. 60/188,599, filed on Mar. 9, 2000.

(51) Int. Cl. G06F 17/60

(52) U.S. Cl. 705/40

(57) ABSTRACT

A payee (a vendor) creates bill 46 with account information 14 and activity 22 printed in alphanumeric characters and in a barcode symbol 42. Bill 46 is sent in the mail to a payer (a customer). The payer scans symbol 42 into a PC 52 (personal computer). Scanning wand 48 decodes symbol 42 and transmits it to PC 52. An editor 54 is installed on PC 52. Editor 54 interprets signals and displays interactive visual image 60 on a display terminal 62. The payer verifies that the information on image 60 is the same as on bill 46. The payer clicks the next button with a mouse 66 to show a transaction display 68 on terminal 62. The payer determines that he or she wishes to pay amount 73 and enters amount 73 on display 68. The payer instructs editor 54 to transfer a payment order 82 either to an electric banking software program 58 installed on PC 52 or to an online program 59 accessible through a modem 55 of PC 52.

### BACKGROUND-FIELD OF INVENTION

This invention relates to the paying of bills by consumers, either by computer-generated checks or electronic banking, utilizing personal computers specifically being facilitated by coded indicia, such as barcode symbols, printed on the bill.

### BACKGROUND-DESCRIPTION OF PRIOR ART

People in this and many other countries have become comfortable with seeing and using coded indicia in conjunction with consumer charges and banking transactions. Three of the most prominent uses of coded indicia are magnetic strips and smart cards (cards containing embedded integrated circuits), used on credit cards, debit cards, and ATM cards; and barcode symbols, such as the Universal Product Code often found on sales tags. In these instances, the peripheral and computer are the property of, or in the possession of the vendor or his agent.

Customers often perform the physical act of scanning a magnetic strip through a peripheral. Examples of this are inserting the card into a slot at a self-service gas pump or an ATM, and “swiping” the card at a supermarket checkout counter. Magnetic stickers are also applied to store merchandise in a manner similar to barcode symbol stickers. The magnetic images from these stickers are read by a peripheral that is usually a flat rubberized plate set on the store counter.

Smart cards can communicate with a reader or receiver (the peripheral) in one of two forms. With a contact smart card the receiver contacts a small chip on the card to make the connection. A contactless smart card can communicate via antenna, eliminating the need to insert and remove the card by hand. To use a contactless card, all a person has to do is get close to a receiver and the card will begin communicating with it.

In the case of barcode symbols, a sales clerk in the presence of the customer usually does the scanning, frequently with a hand held scanner. Typically, the scanner decodes the barcode symbol and some of the information is shown on a display screen so that both the customer and the sales clerk can read it. At the same time, software in the vendor's computer will determine pricing, add the item to the customer's sales slip, and note the sale of the item in the store's inventory control system.

One of the most common barcode symbols used in retailing is the UPC (Universal Product Code). The first 6 digits of the 12 digit UPC are the Manufacturer's ID, the number assigned by the UCC (Uniform Code Council) to uniquely identify a manufacturer or company.

Often the document with the barcode symbol printed on it will also have some of the same information in human-readable format. Clothing sales tags, for example, can have size, color and price in both formats. In some large self-service stores, barcode symbol scanners have been placed at the end of aisles so that when customers can not visually determine the price of an article, they can scan the barcode symbol and see the price on a display device.

Some food supermarkets have introduced customer-scanning check out counters. The customer scans the barcode symbol of each item and the item's name and price are displayed on a screen. When the customer has finished scanning, the computer prints out a sales slip, which the customer takes to a manned counter. The clerk at that counter checks the sales slip for accuracy and collects the purchase amount from the customer.

Thus, over a period of years, consumers have become used to the simplicity, reliability and accuracy of coded indicia in handling financial transactions.

Companies have introduced fountain pen sized and fist sized, hand held barcode symbol scanners to use with PCs (IBM PC/XT/AT, IBM PS/2 and Apple Macintosh compatible personal computers). The scanners are referred to as “pen wand”, “wedge wand”, “handheld CCD (Charge Coupled Device)” or “handheld laser” scanners. These scanners are also referred to as “barcode readers” since they come with the decoder built into the scanner so no external decoding software is required. The scanner connects between the PC and the keyboard (or directly to the ADB Bus, in the case of the Macintosh). These scanners have the ability to read most commonly used barcode symbols and automatically discriminate among them. As the wand is scanned across the barcode symbol, the decoder will transmit the data to the PC as if it were typed on the keyboard; therefore no PC software drivers are required to convert the coded indicia to an alphanumeric display. Another procedure is for the pen wand to internally store the information of one or more scans. When the wand is placed in a pen holder type docking device, the data can be uploaded to the PC.

Once the data from the coded indicia is uploaded to the PC, additional, mission specific, software is needed to further process the information.

Traditionally, households receive numerous bills or invoice each month by regular first class mail (nicknamed by some as “snail mail”), for consumer goods or services that they have purchased. The consumer now becomes payer, both in the sense of being the person(s) incurring the bills and in the sense of paying the bills through a banking institution. Typically, payer (s) of these bills will review the bill, write a check naming the payee, the amount payer decides to pay, both in digits and alphabetically, add payer's account or billing identification number on the memo line of the check and the date, and sign the check. The payer then will detach and fill in a stub attached to the bill, insert the check and the stub into a return envelope supplied by the payee, being careful that the return address shows through the window of the return envelope, affix the payer's return address on the envelope, seal it, affix a stamp, and place it in the mail. In addition, the payer writes the check number, to who paid, the amount paid, and his or her balance in the checkbook register.

The increasing use of PCs (Personal Computers) has made alternate ways of paying bills feasible, such as computer generated paper checks, and electronic banking from the home. In spite of the amount of effort and cost involved in paying bills as enumerated in the preceding paragraph, only a small percentage of those payer s who could use these alternate systems actually do. This is probably due to the payer s anticipation that installing such computer assisted payment systems would be difficult and, after installing the software, it would be a complex, time-consuming task to set up each billing account. Thus, the PC might take more time than it would save.

To set up each account, the payer would have to type in such things as the payee's name, address (either regular or electronic), account number, and phone number. Once set up, these billing accounts can be stored indefinitely. However, only a few monthly bills, such as fixed rate mortgages and car loans, can be scheduled for identical repeating payment. Most other bills, such as homeowner's equity, credit cards, and utility bills, vary from month to month. Still other bills, such as those from gasoline companies and department stores, might have no new balance and no new charges for several months. Finally, there is the one time only bill, for example from a contractor.

Once a regular billing account has been set up, except for those bills that are scheduled for repeating payments, the payer still must pay the bill himself by manually looking up each billing account in an index or typing in an identifying name. Adding to this inconvenience is that bills are usually paid in random order.

Many owners of PCs are keyboard challenged. For this reason, flatbed and sheet feed scanners, used to photocopy images with the computer, often come with OCR (Optical Character Recognition) software included. This type of OCR software is designed to recognize alphanumeric characters. It would be useful if OCR software could interpret bills so that the information could be entered into the PC automatically with sufficient accuracy. However, OCR software has to overcome the obstacles of different fonts, sizes, and formats. They do so by comparing words and phrases to their built in dictionaries and thesauruses. Letters of the alphabet, with the exception of “a” and “I”, have no stand alone meaning, whereas numbers do. Therefore, OCR software that is currently available for PCs is not accurate enough to transfer the numerical information from paper bills to PCs.

### SUMMARY OF THE INVENTION

Objects and Advantages

An object of the invention is to facilitate the payment of monthly bills by consumers (payer s) by printing a barcode symbol, or other coded indicia. The barcode symbol would contain pertinent information, such as the payee's name, the payer account number, amount due, minimum payment, and date due on each bill sent through the mail. This barcode symbol would be in addition to similar information conventionally shown in human readable form, and would be printed at a convenient location for scanning, such as at the upper edge of the bill. The payer could scan the code using a hand scanner so that the information shown on the paper bill is repeated on the display for verification. At the same time, software could access an existing payee electronic banking account from the PC's memory or set up a new account. The format of the display could be programmed by a payee to suggest the amount(s) to be paid and when a payment is due. A credit card bill, for example, could list the choices of paying the minimum amount, paying an intermediate amount, or paying the new balance. The payer could click a box on the display with his or her mouse to pick the first or third choice, or type in an amount next to the second choice. The payer would then approve the transaction, thus initiating the processing of the information by the PC, utilizing software to either print a check or transmit payment instructions to the payer's bank.

### BRIEF DESCRIPTION OF THE DRAWINGS

FIG. 1 shows the data printed in a barcode symbol printed on a bill.

FIG. 2 shows the flow of information processed by a vendor to create a bill and an image of the bill in the preferred embodiment.

FIG. 3 shows a personal computer with a display terminal and a barcode reader.

FIG. 4 shows an image on a terminal display with provisions for payer interface.

FIG. 5 shows a transactional confirmation display.

FIG. 6 shows an information flow for bill payment.

FIG. 7 shows a representation of a barcode initially sent by a payee to a payer in the second embodiment of the invention.

FIG. 8 is an image of a bill in the second embodiment.

FIG. 9 is an image of a bill in the third embodiment.

FIG. 10 shows a computer generated check, both as a visual image and as a printout.

FIG. 11 shows examples of barcode symbols.

### DEFINITION OF BARCODE SYMBOL

A barcode is defined as a series of vertical bars or a graphical bar pattern which can encode numbers and letters in a format which can be retrieved and interpreted by a combination of an optical scanning device and decoding software.

A barcode symbol is defined as a combination of bar code characters required by a particular symbology (the language used in barcode technology) that forms a complete, scannable entity.

Types of Barcode

There are currently two general types of barcodes. FIG. 11 shows a linear barcode 85. Barcode 85 can also be printed as a ladder (vertical) barcode (not shown).

The second type of barcode is a 2D (two-dimensional) barcode 86. An enlarged 2D-barcode section 88 is also shown. Another example of a 2D barcode is a Maxicode 90. Maxicode 90 uses a pattern of small dots and a bull's eye in the center.

High density, two-dimensional barcode symbols can hold more than one kilobyte of information in less than a one-inch (6.45 centimeters) square area. A single symbol has the capacity to encode alphanumeric text filling a letter-sized document

Information Included in Barcode Symbol of Preferred Embodiment

Data in a barcode symbol 42 of the preferred embodiment is comprised of an access code 13, account information 14 requested by banking software program 58 or online program 59 of the payee, and financial activity 22 for the current billing period. Neither banking software program 58 nor online program 59 is a part of the patent.

Access code 13 is a predetermined or pseudorandom signal that acts as a key for the decryption of symbol 42.

An example of banking software program 58 is Intuit Inc.'s Quicken® 6. The Quicken online payment service is available for check writing accounts with any U.S. financial institution. The Quicken service requests that a data file 56 be established in an internal data file 56 of PC 52 for each the payee in banking software program 58. The information in data file 56 is comprised of the payee's name 18 and address 19, the payer account number 16 (an account number that the payee uses to identify the payer), and a phone number 21 for contacting the payee. Although Quicken uses the term “online”, the payer actually identifies the payee, creates several payment instructions offline on PC 52, and sends them together in one phone call to the financial institution.

An example of an online program 59 is the Wells Fargo Online™ Banking. Using the Internet, the Wells Fargo program stores the payee's data file 57 in online data file 57 for each the payer. The information in data file 57 is identical to that of data file 56 since Wells Fargo requests the same information as is in data file 56 from each the payer for each the payee. In some cases the payee may be on a list that is already in the Wells Fargo Merchant Directory. With program 59, using the modem (not shown) of PC 52, the payer goes on line and creates instructions on the web page provided to the payer by program 59.

To complete the payment transaction from the payer to the payee, both Quicken and Wells Fargo need to know amount to pay 46 and a send date 78.

With respect to send date 78, some payees are set up to receive an EFT 31 (electric funds transfer). This type of payment usually has a lead-time of one to two business days. Software banking software program 58 and online program 59 each handle EFT 31. The payment center electronically transfers the money directly from payer's account to the payee's account.

If the payee is not EFT 31 enabled the financial institution or bank will print a check and send it through the U.S. mail. Quicken and Wells Fargo both recommend a lead-time of four to five business days.

It is in the best interest of the payee to be EFT 31 enabled since enabled payees receive payment information in an electronic format that automatically updates their accounts payable system. This allows the payee to reduce staffing in its billing department

Although not requested by software banking software program 58 or online program 59, the payee can include “EFT 31 enabled” in symbol 42. This will help the payer to select send date 78. Quicken and Wells Fargo both keep records of merchants that are EFT 31 enabled; however, the payer, not the financial institution, is responsible for selecting send date 78 that avoids late payment charges. On the other hand, the payer does not want send date 78 that is too soon because the money is taken out of the payer's account as of send date 78.

Typical financial activity 22 would be comprised of a minimum payment due 29, a payment due date 30, and a new balance 28. Activity 22 might also be comprised of accrued interest 26, and new charges 25 made by the payer since the last billing period.

### DETAILED DESCRIPTION OF THE PREFERRED EMBODIMENT

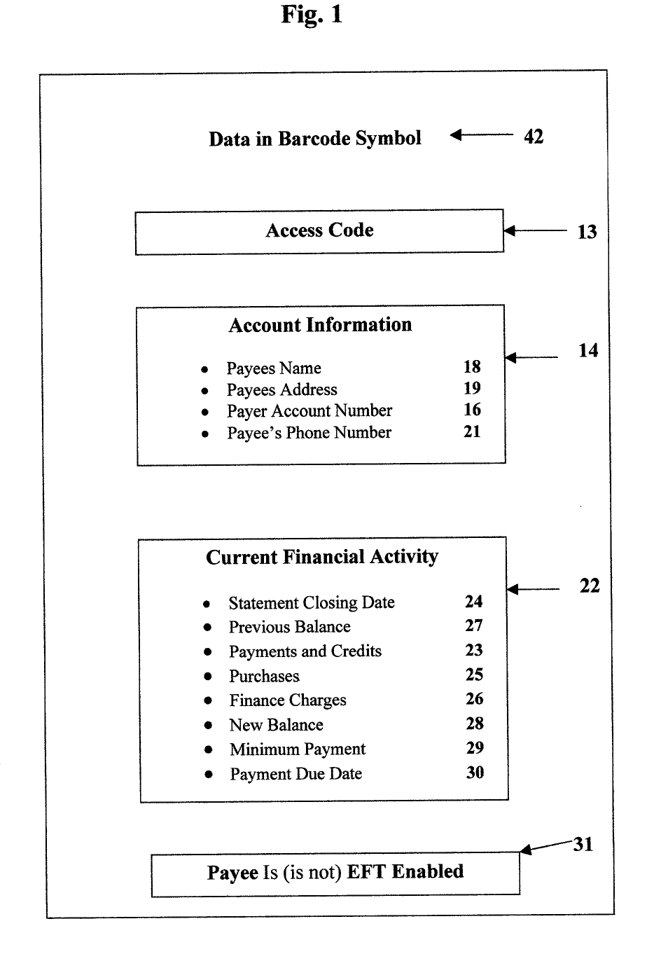

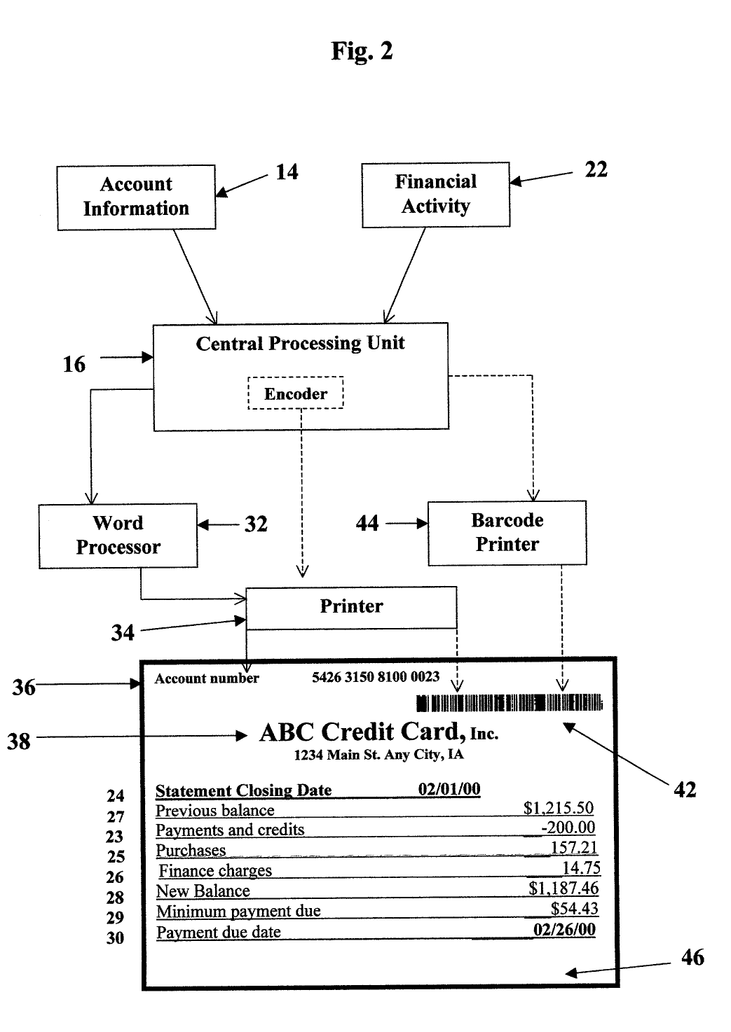

In the preferred embodiment, FIGS. 1 and 2 show a procedure that a payee would use to print a document referred to as a bill 46.

A CPU 13 (central processing unit) of the payee accumulates an account information 14. Account information 14 is comprised of the payer's account number 16 with the payee and phone number 21 of the payee. CPU 13 also accumulates the payer's recent financial activity 22 up to the statement closing date 24. Activity 22 is comprised of new purchases 25, finance charges 26, new balance 28, and time bounding such as closing date 24 and payment due date 30. CPU 13 processes instructions to a word processor 32, which formats and sends them to an alphanumeric printer 34. Processor 32 causes printer 34 to print account information 14 and activity 22 on a sheet of paper 36 as alphanumeric information 38. CPU 13 is also programmed to encode the data into a barcode processing instruction 40. Generally, barcode printers have the ability to encode data into barcode images. If printer 34 is limited to alphanumerical characters, then processing instruction 40 causes a barcode printer 44 to add symbol 42 in the top margin of the paper 36. If printer 34, for example a laser printer, has the ability to print characters other than alphanumerical, CPU 13 will encode information 14 and activity 22 into processing instruction 40a. Command 41 causes printer 34 to print account information 14 and activity 22 as a symbol 42 in the top margin of the paper 36.

Bill 46 is comprised of paper 36, alphanumeric information 38, and symbol 42.

While symbol 42 in the preferred embodiment is shown printed in the top margin of paper 36, it is obvious that symbol 42 could be printed on any part of the face of paper 36 or on the reverse side of paper 36. Symbol 42 could also be printed on a label that is then adhered to paper 36, or on a separate sheet of paper included in the mailing envelope.

At the end of each billing period, usually monthly, the payee causes bill 46 to be printed for the payer. Using conventional techniques for mailing bills (not shown), bill 46 is collated with other materials such as advertising literature and a return envelope, placed in an outside envelope having payer's address and the postage thereon, and mailed through the postal service to the payer.

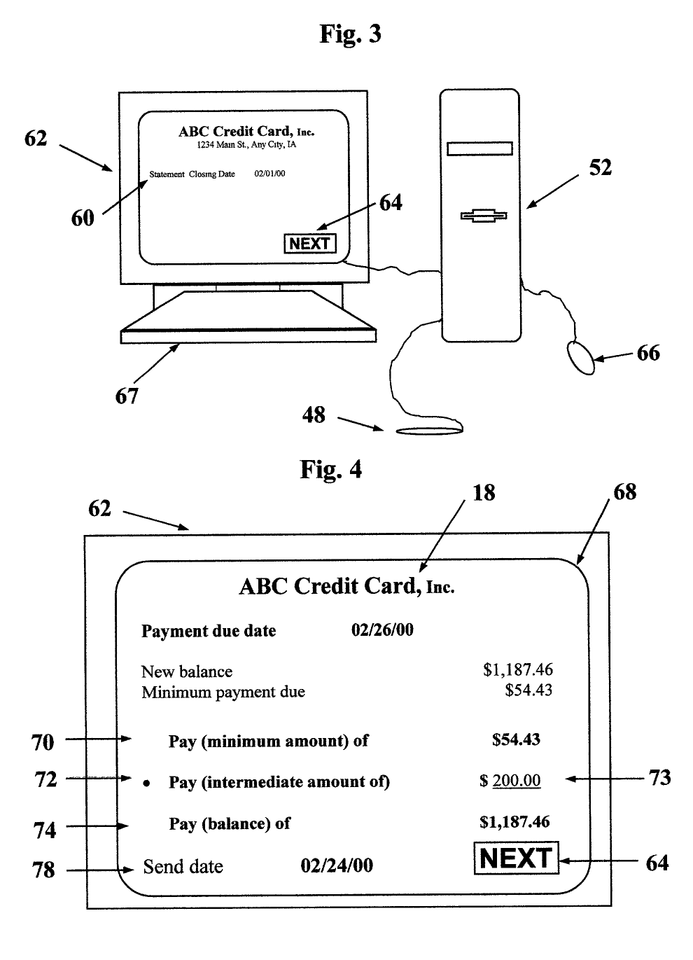

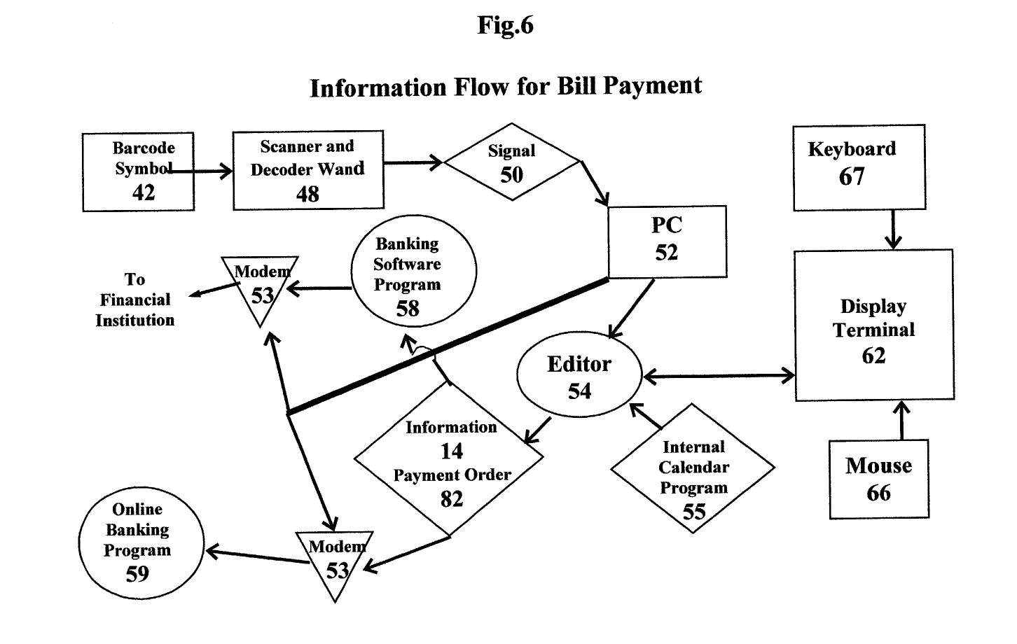

In the preferred embodiment, FIGS. 3-6 show a procedure that the payer would use to pay bill 46.

In FIG. 3, the payer “swipes” scanning wand 48 across symbol 42 to retrieve account information 14 and activity 22. Wand 48 acts as a decoder deciphering account information 14 and activity 22 and converting it into a signal 50. Wand 48 is attached to PC 52. Signal 50 creates an interactive visual image 60 of account information 14 and activity 22 on a display terminal 62 of PC 52.

A control instructions editor 54 has been installed in PC 52. Editor 54 processes signal 50. Editor 54 is programmed to determine if access code 13 is present in signal 50. If access code 13 is present in signal 50, editor 54 will automatically integrate account information 14 and activity 22 into editor 54. Editor 54 enables the payer to interface with image 60 utilizing user data entry such as a mouse 66 and a keyboard 67. Image 60 follows the same format of alphanumeric information 38 so that the payer can easily compare image 60 with account information 14 and activity 22 to feel comfortable using editor 54 for payment transaction instructions.

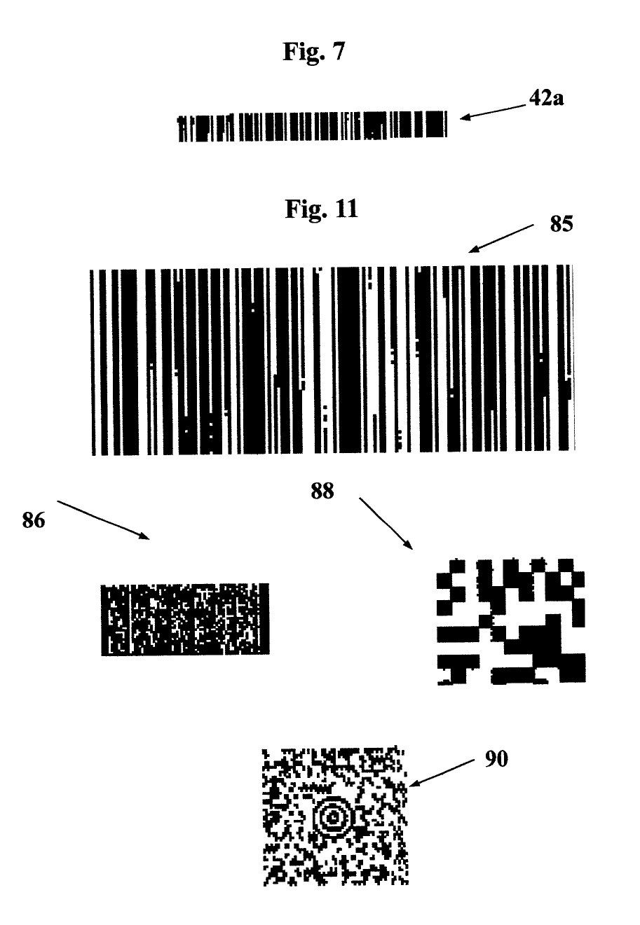

A “NEXT” button 64 is located on the lower right corner of image 60. Clicking “NEXT” button 64 with mouse 66 causes a transaction display 68 to appear on terminal 62 as shown in FIG. 7. Since the payee allows installment payments, the payee offers the payer choices of clicking a button 70 labeled “Pay (minimum) amount of $54.43”, a button 72 labeled “Pay (intermediate amount) $___.___”, or a button 74 labeled “Pay new balance of $1,187.46”.

Editor 54 polices for input errors. Buttons 70, 72, and 74 are mutually exclusive and mouse 66 must click one of them. If mouse 66 clicks button 72, an amount between $54.43 and $1,187.46 must be entered in the blank space prior to proceeding further. If “NEXT” button 64 is clicked without transaction display 68 being properly filled out, a conventional error message (not shown) will appear. The payer has clicked button 72 to pay the intermediate amount of $200.00 by and using keyboard 67 to enter 200.00 in the space provided.

When installing editor 54, using keyboard 67, payer entered the number of days to allow before payment due date 30 to determine send date 78. The payer has elected two business days if the payee is EFT 31 enabled, and five business days if the payee is not EFT 31 enabled. Editor 54 has an internal calendar program (not shown) to determine business days.

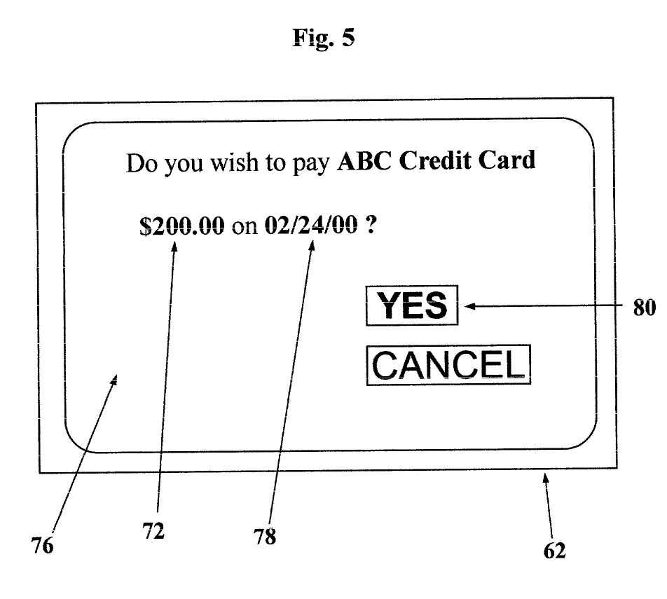

If transaction display 68 has been properly filled out, when the payer clicks “NEXT” button 64, a transaction confirmation display 76 appears on terminal 62. FIG. 5 shows confirmation display 76 on terminal 62. Display 76 also shows send date 78 that has automatically been calculated by editor 54. Payment order 82 is comprised of amount 56 of $200.00 and send date 78 02/24/00. Clicking a “Yes” button 80 causes editor 54 to send account information 14 and payment order 82 to either electronic banking software program 58 or to modem 55. Modem 55 routs information 14 and payment order 82 to banking on line online program 59 via the Internet. Banking online program 59 would be accessed through the Internet by means of a conventional shortcut icon on the PC 52 desktop (not shown). Software banking program 58 would have been previously installed on PC 52. Program 58 includes a means to connect to a financial institution with modem 55.

While this embodiment is illustrated with banking software program 58 and online banking program 59 currently available through third parties, symbol 42 includes sufficient data that editor 54 can be designed to transfer account information 14 together with payment order 82 to any financial institution by using modem 55 and telephone service directly or over the internet to the financial institutions web site.

### Other Embodiments

Description of the Second Embodiment

In the second embodiment, account information 14 has been previously installed in data file 56 or data file 57 on a permanent or semi-permanent basis for periodic use by the payer. The payer may have installed account information 14 in a conventional manner by following the current instructions in either banking software program 58, or online banking program 59.

Another way that the payer could pre-install account information 14 in the second embodiment would be by “swiping” a barcode symbol 42a. FIG. 7 shows symbol 42a. Symbol 42a is comprised of account information 14. Symbol 42a has been printed by the payee and sent to the payer either with a previous bill or in a separate mailing. Editor 54 installs account information 14 in either data file 56 or data file 57.

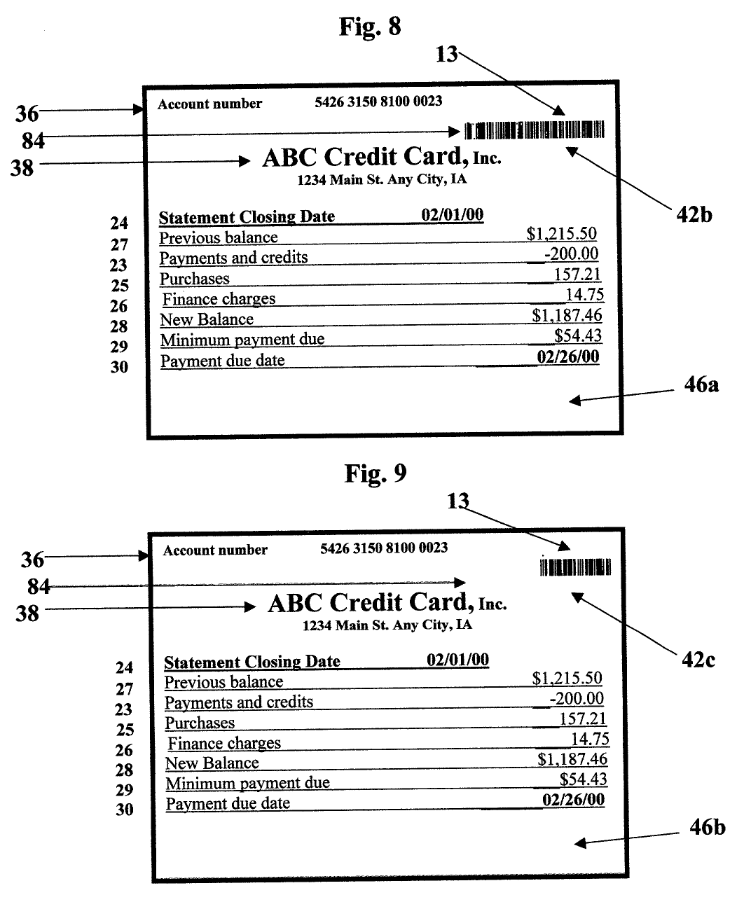

In FIG. 8 the payee causes bill 46a to be printed. Bill 46a is comprised of alphanumeric information 38 and a barcode symbol 42b. Symbol 42b is comprised of financial activity 22, a merchant ID (identification) 84 and access code 13.

The payer “swipes” symbol 42b with wand 48 to generate signal 50. Editor 54 utilizes ID 84 from signal 50 to access account information 14 from either data file 56 or data file 57. Editor 54 merges account information 14 with activity 22 to create visual image 60 on monitor terminal 62.

From this point on, the second embodiment is similar to the preferred embodiment.

### Description of the Third Embodiment

In the third embodiment, the payer pre-installs account information 14 as described in the second embodiment.

In FIG. 9 the payee causes bill 46b to be printed. Bill 46b is comprised of alphanumeric information 38 and a barcode symbol 42c. Symbol 42c is comprised of access code 13 and ID 84.

The payer “swipes” symbol 42c with wand 48 to generate signal 50. Editor 54 utilizes ID 84 from signal 50 to enter the payee name in banking software program 58 or online banking program 59. The appearance of a visual image 60 will vary depending on the vendor supplying either program 58 or program 59, but image 60 will be comprised of payee's name 18, amount 75 (to pay), and send date 78, as shown in FIG. 4.

Many owners of PCs also own hand held, sheet feed, and flat bed scanners for the purpose of scanning visual images of pictures and text into their PC. These scanners could be used to read symbols 42, 42a, 42b, and 42c by installing a decoding software program in PC 52.

While wand 48 is shown wired to PC 52 in the preferred embodiment, wand 48 could be connected by a wireless link, as some keyboards and mice are. It would also be feasible to incorporate a wand within a mouse to reduce desktop clutter.

Other Users

While the descriptions of the embodiments imply that the payers are individual consumers, it is evident that businesses could use the same method to pay bills that have been mailed to them. This would enable some companies to reduce the man-hours in their accounts payable function.

Other Coded Indicia

Other coded indicia can be stored on a magnetic record carrier (magnetic strip) or on an imbedded integrated circuit (smart chip).

The scanning device for the magnetic record carrier uses a transducer assembly. The transducer assembly reads the magnetic strip and senses the variation of characteristics therein. While normally the magnetic strip on a plastic card, such as a credit card, is “swiped” through a stationary transducer assembly, it would be easy to design a hand held transducer assembly to “swipe” across a piece of paper.

The integrated circuit can be either a “contact” or a “contactless” type. The contact type is plugged into a reader so that a probe will touch the chip. The “contactless” has an antenna in order to transmit a signal to a receiver when in close proximity to it.

With the magnetic strip and the smart chip, once the indicia is read the processing of the data is the same as the above three embodiments.

Computerized Check Printing

Intuit and other companies offer preprinted blank checks that can be used to write checks using their software. However, checks printed entirely on a peripheral printer of a PC are just as legal. In practice, a numerical code 96 at the bottom of checks should be included in order for the checks to be processed through the Federal Reserve check clearing houses.

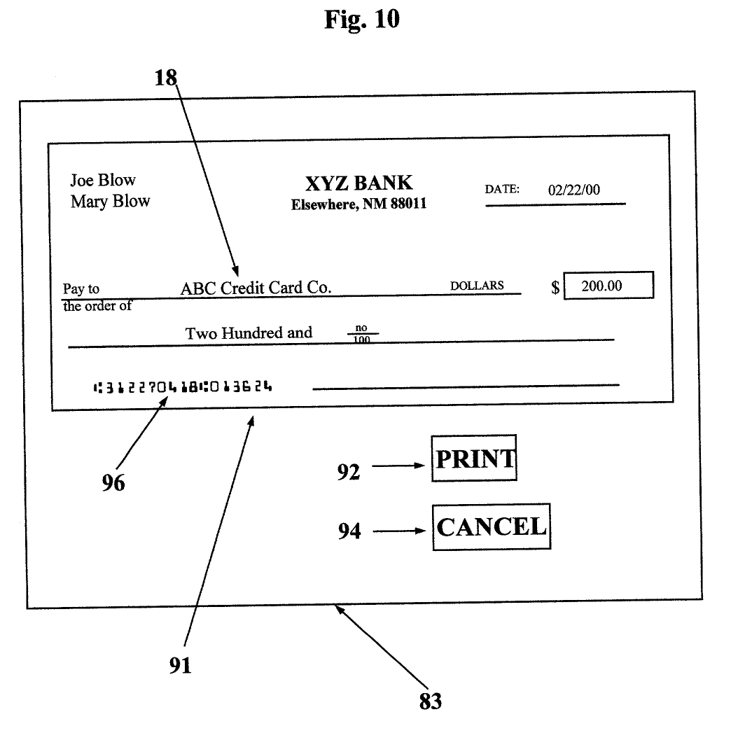

FIG. 10 shows a visual image 83 of a check 91 for a payment from the payer to the payee. In the database of PC 52 is a formatting means (not shown) to create a blank check form. Following either the procedure of the preferred embodiment or the second embodiment, the payer views image 60 and display 68. Editor 54 merges payee's name 18 with the formatting to create a visual image 83 of the filled out check. After reviewing image 83, the payer clicks a “PRINT” button 86 to make a hard copy of the check or a “CANCEL” button to clear the form.

Summary, Ramifications, and Scope

Almost half of the households in the United States do not yet have computers. In order to be sure that all customers have received their bills in a proper fashion, many bills will continue to be sent through the mail. Adding barcodes or other coded indicia to these bills would offer a valuable service to customers who wish to pay their bills with the aid of a computer. Banks might give their customers a proprietary version of the software and a scanner. Use of encryption included in the software for sending the account information and payment order from the customer to the bank would assure privacy and that the software would be used exclusively with that bank.

Using this invention, the household bill payer can pay bills simply by “swiping” each bill, clicking his or her computer mouse a few times, typing in or selecting a payment amount, and clicking the mouse again to complete the payment.

I claim:

1. A method of a payee facilitating the payment of bills by payers, said bills being comprised of:
(a) printing in human readable format, said printing comprised of payee identification and a payment due from each of said payers to said payee,
(b) coded indicia comprised of payee identification means, said payee having a means of sending said bill and said indicia through the mail to each of said payers, whereby at least some of said payers use peripheral means to decode said indicia into data, each said peripheral means transferring said data to a computer, said computer having a control instructions editor for identifying said payee from said data, said editor selecting a file about said payee from an electronic banking data base storage means accessible to said computer.

2. The coded indicia of claim 1, said indicia further comprised of said payment due.

3. The coded indicia of claim 1, said indicia further comprised of a date that said payment is due.

4. The coded indicia of claim 2, said indicia further comprised of said payee's address and an account number used by said payee to identify each said payer.

5. The coded indicia of claim 1, said indicia further comprised of an access code, said code being converted into a part of said data by said peripheral, said code being understood by said editor, whereby said editor selectively processes said data only when said code is included in said data.

6. A bill paying apparatus comprising:
(a) a document comprised of payee identification and payment due in human readable format, and coded indicia comprised of a payee identification means, said document having been received in the mail by a payer;
(b) a peripheral means to read said indicia;
(c) a decoder to convert said indicia into decoded data;
(c) a control instruction editor that can, at least, determine said payee identification,
(d) a computer;
(e) a display terminal.

7. The apparatus of claim 6, comprised of said display terminal, further comprised of a computerized payment disbursement means.

8. The display terminal of claim 7 further comprised of:
(a) a visual image of said payee identification displayed on said display terminal;
(b) a user interface control means to input instruction data, said instruction data comprised of a payment amount;
wherein said computer merges said payee identification with said instruction data and outputs the merged data to said payment disbursement means.

9. The display terminal of claim 8 said instruction data further comprised of a send date instruction whereby said financial institution will transfer said payment amount to said payee in accordance with said merged data.

10. The control instructions editor of claim 6, said editor further routing said decoded data to select said payee's file from an electronic banking data base accessible to said editor.

11. The editor of claim 10, said editor further identifying payment due data embedded in said decoded data, said editor merging said payment due data with an address of said payee and an account number that said payee uses to identify said payer, said editor processing said payment due data, said address, and said account number into image data, said image data being displayed as a visual image on said display terminal, said image having, in part, a display area for user payment instructions.

12. The apparatus of claim 8 wherein said payment disbursement means is a printer, whereby said printer is caused to print a check, said printing on said check being comprised of an order to pay to said payee, and an amount to pay.

13. The editor of claim 6, said editor further identifying an access code embedded in said decoded data, said editor selectively processing said decoded data only when identifying said access code.

14. A computer assisted method of transacting the payment of bills, each said bill comprised of a human readable document and coded indicia, said bills sent through the mail by payees to payers, said indicia comprised of a payee identification means, at least some of said payers each having:
(a) a computer,
(b) a display terminal,
(c) a peripheral means to read said indicia,
(d) a decoder to convert said indicia into decoded data,
(e) a control instruction editor that can, at least determine said payee identification,
wherein at least some of said payers can process said indicia to assist in the implementation of the payment of said bills.

15. The computer assisted method of claim 14, said editor further acquiring said payee's identification from said decoded data, said editor displaying said payee identification on said display terminal, wherein each of some said payers, using a user interface control means, inputs a payment instruction comprised of a payment amount and a send date to said display terminal to create a visual display of a payment order.

16. The computer assisted method of claim 15, each said decoded data further comprised of a payment due date wherein each said editor can determine a send date by merging predetermined data with said payment due date said editor creating a visual image of said send date and said payee identification on said display terminal.

17. The computer assisted method of claim 15, said payer further having a modem means to transfer data to a financial institution, said payer routing said payment order to said financial institution whereby said financial institution transfers said payment amount to said payee in accordance with said payment instruction.

18. The computer assisted method of claim 15 wherein said payment disbursement means is a printer, whereby said printer is caused to print a check, said printing on said check being comprised of an order to pay to said payee, and an amount to pay.

19. The computer assisted method of claim 15, said editor further routing said decoded data to select said payee's file from an electronic banking data base accessible to said editor, said payee's file being comprised of said payee's address, a payer account number, and whether payee is EFT enabled.

20. The editor of claim 15, said editor further identifying an access code embedded in said decoded data, said editor selectively processing said decoded data only when identifying said access code.
